(19) United States
(12) Patent Application Publication
(10) Pub. No.: US 2012/0191280 A1
(43) Pub. Date: Jul. 26, 2012

(54) CONTROL APPARATUS FOR SERIES HYBRID VEHICLE

(75) Inventor: Akiyoshi Ohno, Shizuoka-Ken (JP)

(73) Assignee: Suzuki Motor Corporation, Shizuoka-ken (JP)

(21) Appl. No.: 13/350,938

(22) Filed: Jan. 16, 2012

(30) Foreign Application Priority Data
Jan. 21, 2011 (JP) 2011-010629

(51) Int. Cl. B60W 20/00

(52) U.S. Cl. 701/22; 180/65.265

(57) ABSTRACT

A control apparatus for a series hybrid vehicle includes an engine, a generator, a battery, and a drive motor increases an engine rpm according to an accelerator opening while maintaining a high fuel efficiency to give a driver an acceleration feeling because of the increased engine sound. A control means determines a target engine rpm based on an accelerator opening detected by an accelerator opening detecting means, and sets as the target engine rpm, an engine rpm at which a power generation efficiency is maximum when the accelerator opening detected by the accelerator opening detecting means is minimum, and sets as the target engine rpm an engine rpm at which an output is maximum when the accelerator opening detected by the accelerator opening detecting means is maximum.

### CROSS-REFERENCE TO RELATED APPLICATIONS

The present application claims priority from Japanese Patent Application No. 2011-010629, filed in the Japanese Patent Office on Jan. 21, 2011, the disclosure of which is hereby incorporated herein by reference.

### BACKGROUND OF THE INVENTION

The present invention relates to a control apparatus for a series hybrid vehicle and, more particularly, to a control apparatus for a series hybrid vehicle in which wheels are driven by a motor and an engine is used only for power generation.

A series hybrid vehicle as a vehicle includes: an engine; a generator driven by the engine; a battery charged by the generator; and a motor that drives wheels by generated power of the generator or discharged power of the battery.

A control apparatus for a hybrid vehicle according to JP 2008-55997 A is the apparatus in which engine output control reduces generating load on the generator when the hybrid vehicle is rapidly accelerated.

However, conventionally, in a series hybrid vehicle in which instantaneous power required for vehicle acceleration is always supplemented with power generation by an engine, acceleration and reactivity of the vehicle largely depend on an output and reactivity of an engine, thus requiring an engine with high output and high response. In addition, an efficiency of the entire power generation system including the engine and a generator cannot necessarily operate on an efficient operating curve, which may be disadvantageous for improving fuel efficiency. Furthermore, there is a case in which the vehicle must be driven in an engine revolution range with heavy vibrations and noise. Furthermore, there has been a case in which pedestrians do not notice the moving vehicle when the engine has been stopped during low-speed moving.

In addition, in a series hybrid vehicle in which generated power by an engine is set to be always constant, noise and vibrations from the engine do not correspond to acceleration change of the vehicle, and thus disadvantageously, a driver has been given a feeling of strangeness.

### BRIEF SUMMARY OF THE INVENTION

Consequently, an object of the present invention is to provide a control apparatus for a series hybrid vehicle in which an engine rpm is increased according to an accelerator opening while maintaining a high fuel efficiency to thereby give a driver an acceleration feeling because of the increased engine sound.

This invention provides a control apparatus for a series hybrid vehicle including an engine, a generator driven by the engine, a battery charged by the generator, and a motor that drives wheels by generated power of the generator or discharged power of the battery, the control apparatus includes accelerator opening detecting means that detects an accelerator opening, and control means that determines a target engine rpm based on the accelerator opening detected by the accelerator opening detecting means, in which the control means sets as the target engine rpm an engine rpm at which a power generation efficiency is maximum when the accelerator opening detected by the accelerator opening detecting means is minimum and sets as the target engine rpm an engine rpm at which an output is maximum when the accelerator opening detected by the accelerator opening detecting means is maximum.

The control apparatus for the series hybrid vehicle of the present invention can increase the engine rpm according to the accelerator opening while maintaining the high fuel efficiency to thereby give the driver the acceleration feeling because of the increased engine sound.

### BRIEF DESCRIPTION OF THE DRAWINGS

FIG. 1 is a system configuration view of a control apparatus for a hybrid vehicle (embodiment);

FIG. 2 is a block diagram of the control apparatus for the hybrid vehicle (embodiment);

FIG. 3 is a time chart illustrating change of an engine rpm according to an accelerator opening (embodiment);

FIG. 4 is a graph showing an operating curve in relation to an engine rpm and torque (embodiment);

FIG. 5 is a chart showing transition conditions between each mode (embodiment);

FIG. 6 is a flow chart of control by control means (embodiment);

FIG. 7 is a time chart of control by the control means (embodiment);

FIG. 8 is a flowchart of mode transition (embodiment);

FIG. 9 is a flow chart of a hybrid mode (embodiment); and

FIG. 10 is a chart showing an output, an efficiency, a vibration, and a noise with respect to an engine rpm in each mode (embodiment).

### DETAILED DESCRIPTION

This invention achieves an object of increasing an engine rpm according to an accelerator opening while maintaining a high fuel efficiency and thereby giving a driver an acceleration feeling because of the increased engine sound by setting as a target engine rpm an engine rpm at which a power generation efficiency is maximum when an accelerator opening is minimum and by setting as the target engine rpm an engine rpm at which an output is maximum when the accelerator opening is maximum.

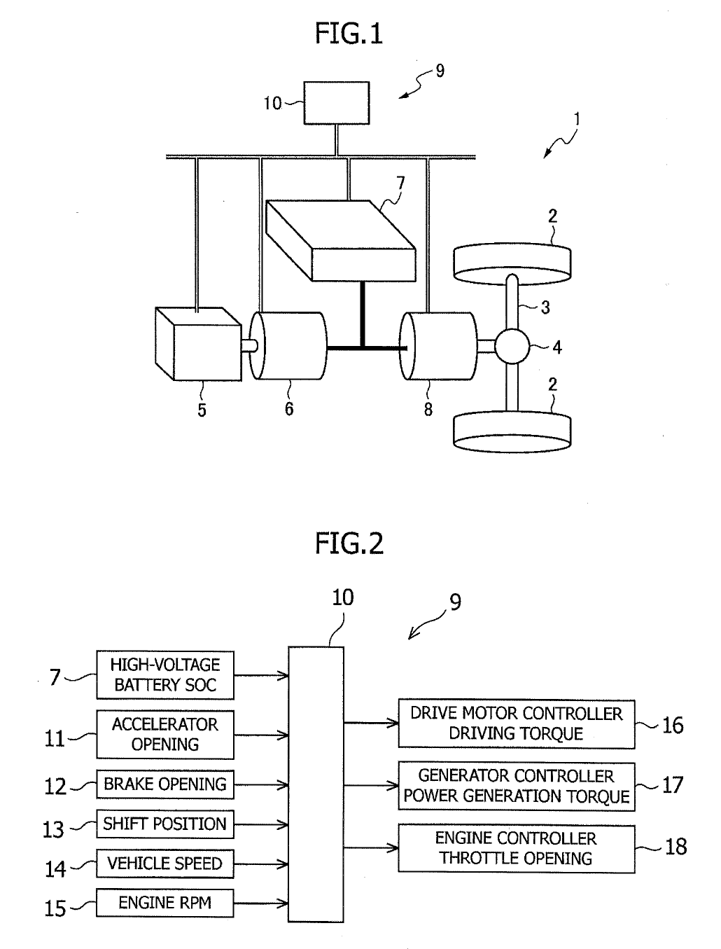

FIGS. 1 to 10 show an embodiment of the present invention.

In FIG. 1, reference numeral 1 is a series hybrid vehicle (hereinafter referred to as a “vehicle”), reference numerals 2 and 2 are wheels, reference numeral 3 is an axle, and reference numeral 4 is a differential device.

The vehicle 1 includes: an engine 5; a generator 6 driven by the engine 5; a high-voltage battery 7 charged by the generator 6; and a drive motor 8 as a motor that drives the wheels 2 and 2 by generated power of the generator 6 or discharged power of the battery 7. The drive motor 8 is electrically connected to the generator 6 and the battery 7, and outputs a drive force to the axle 3 to drive the wheels 2 and 2.

The engine 5, the generator 6, the battery 7, and the drive motor 8 are connected to control means (hybrid controller) 10 included in a control apparatus 9 of the vehicle 1. The control means 10 can detect an SOC (State of Charge) (a remaining charged amount or a charged state) (%) of the battery 7.

In addition, in the control means 10, as shown in FIG. 2, other than the battery 7, at an input side connected to each other are accelerator opening detecting means 11 that detects an accelerator opening as a step-on amount of an accelerator pedal, brake opening detecting means 12 that detects a brake opening as a step-on amount of a brake pedal, shift position detecting means 13 that detects a shift position, vehicle speed detecting means 14 that detects a vehicle speed, and engine rpm detecting means 15 that detects an engine rpm.

Furthermore, in the control means 10, as shown in FIG. 2, at an output side connected to each other are a drive motor controller 16 that outputs driving torque to the drive motor 8, a generator controller 17 that outputs power generation torque to the generator 6, and an engine controller 18 that adjusts a throttle opening, etc., to control the engine 5.

The control means 10 determines a target engine rpm based on an accelerator opening detected by the accelerator opening detecting means 11.

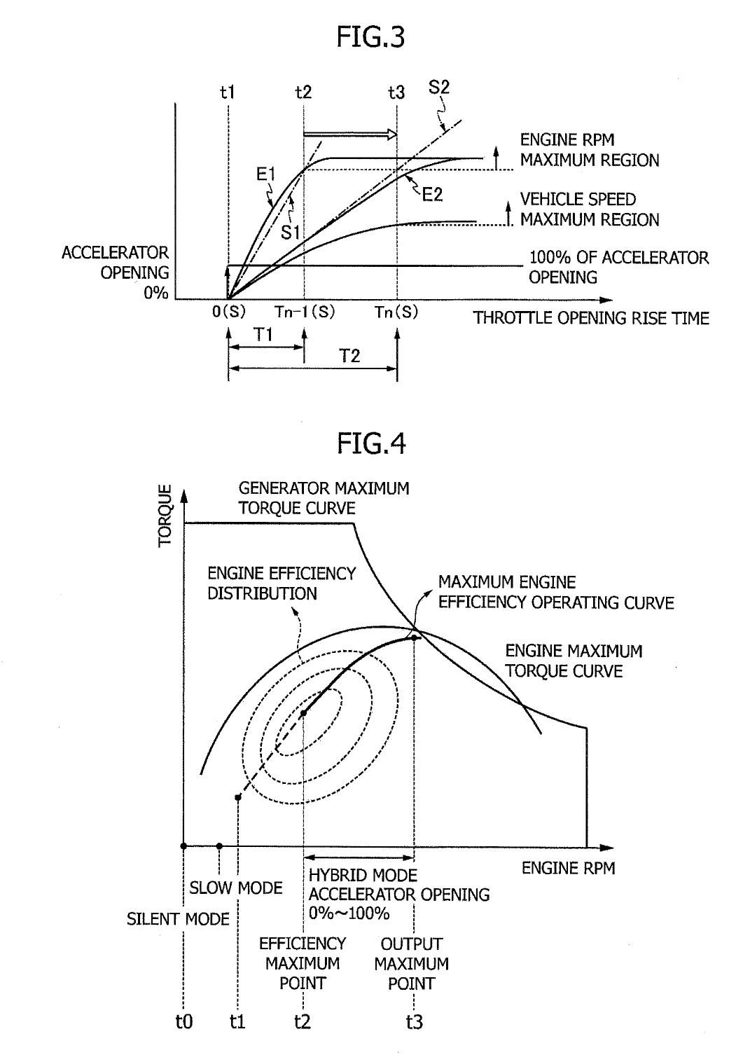

For example, as shown in FIG. 3, conventionally, when the accelerator pedal is stepped on to reach 100% of accelerator opening from 0% and thereby the accelerator is fully opened (time t1), both an engine rpm (shown with a continuous line E1 of FIG. 3) and a vehicle speed (shown with an alternate long and short dash line S1 of FIG. 3) begin to rise before setting operation.

Subsequently, when a predetermined time T1 elapses and the engine rpm falls in a maximum (Max) region (a throttle opening rise time is Tn-1 (sec)) (time t2), the engine rpm has peaked. However, the vehicle speed continues rising even though a predetermined time T2 has elapsed and the throttle opening rise time exceeds Tn (sec) (time t3).

Meanwhile, in the present invention, both the engine rpm (shown with a continuous line E2 of FIG. 3) and the vehicle speed (shown with an alternate long and short dash line S2 of FIG. 3) continue rising to the throttle opening rise time Tn (sec) (time t3).

The control means 10 sets as the target engine rpm an engine rpm at which a power generation efficiency is maximum when the accelerator opening detected by the accelerator opening detecting means 11 is minimum, and sets as the target engine rpm an engine rpm at which an output is maximum when the accelerator opening detected by the accelerator opening detecting means 11 is maximum.

That is, as shown in FIG. 4, a mode is a silent mode when the engine rpm is zero (0) (time t0), and the mode transitions to a slow mode when the engine rpm is increased (time t1). Furthermore, when the engine rpm is increased (time t2), the mode begins to be a hybrid mode (accelerator opening is 0% to 100%) at an efficiency maximum point. Furthermore, when the engine rpm is increased (time t3), the hybrid mode is completed at an output maximum point. An operating curve with a maximum engine efficiency is described from time t2 to time t3.

More specifically, it becomes possible to increase and decrease efficiencies, noise, and outputs according to the level of the engine rpm by setting the operating curve such that the torque is increased along with the increased engine rpm.

The efficiency maximum point (the efficiency is maximum, the noise is minimum, and the output is minimum) is achieved when the engine rpm is minimum, the output maximum point (the efficiency is minimum, the noise is maximum, and the output is maximum) is achieved when the engine rpm is maximum, and the engine rpm and torque transition on the above-described operating curve between these efficiency maximum point and output maximum point. In this case, as for the vibrations, a damping force of an engine mount is set so that a resonance point of an engine body does not appear between the efficiency maximum point and the output maximum point.

As a result of this, as for the efficiencies, when the engine rpm is increased, the engine efficiency is decreased by setting the minimum engine rpm so as to correspond to the efficiency maximum point. As for the noise, since the engine rpm is proportional to engine noise, the noise is at a minimum when the engine rpm is minimum, and thus the noise also increases as the engine rpm increases. As for the outputs, since the maximum engine rpm corresponds to the output maximum point, and an engine output proportional to the engine rpm and the torque is set so as to gradually increase from the efficiency maximum point, the engine output rises according to the engine rpm. As for the vibrations, the damping force of the engine mount is set so that the resonance point of the engine body does not appear between the efficiency maximum point and the output maximum point.

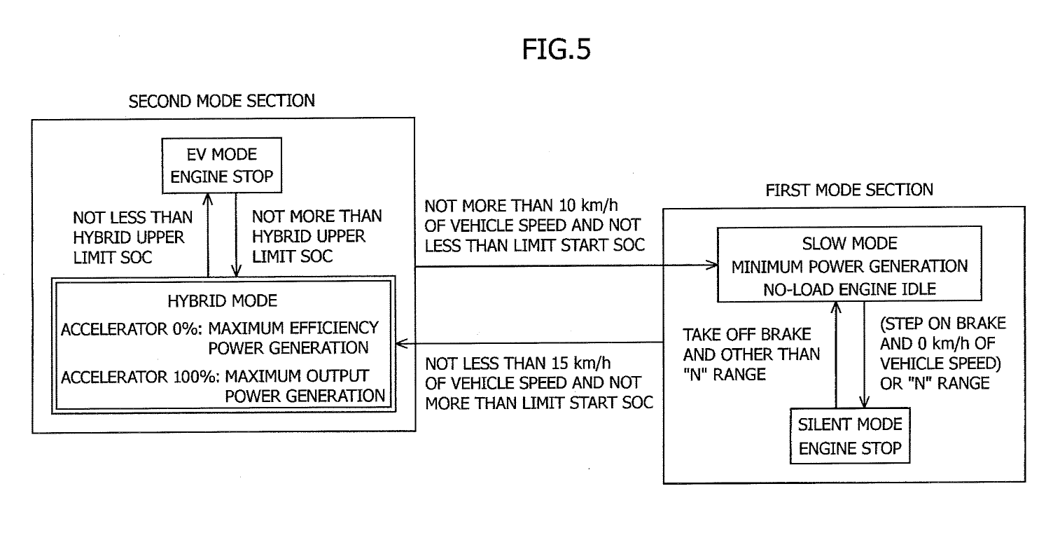

Various modes according to the embodiment respectively transition as shown in FIG. 5.

As shown in FIG. 5, there are a first mode section and a second mode section.

There are a silent mode and a slow mode in the first mode section. The silent mode is the mode in which the engine 5 is stopped. The slow mode is the mode of minimum power generation, no load, and an idle operation state of the engine 5. Transition from the silent mode to the slow mode is performed when the brake pedal is not operated and a shift position is in other than an “N” range. Meanwhile, transition from the slow mode to the silent mode is performed when the brake pedal is stepped on and a vehicle speed is zero (0) km/h or the shift position is in the “N” range.

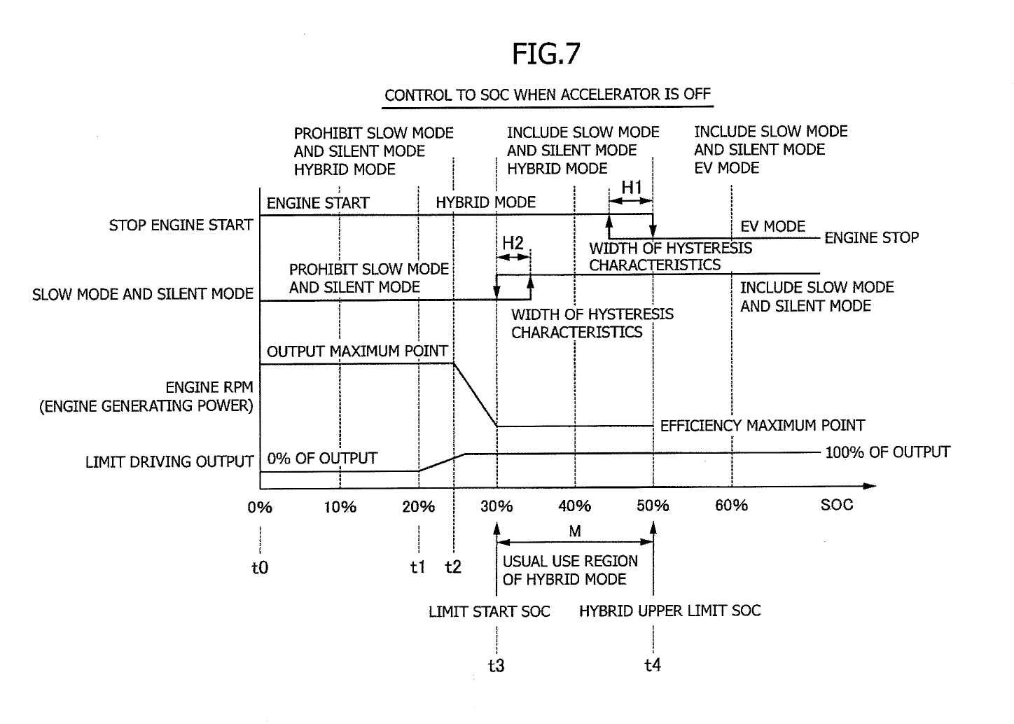

There are a hybrid mode and an EV (electric vehicle) mode in the second mode section. The hybrid mode is the mode in which the engine 5 is operated. An accelerator opening is set in a range of zero (0) % to 100%, and efficiency maximum power generation is achieved when the accelerator opening is zero (0) % and output maximum power generation is achieved when the accelerator opening is 100%. The EV mode is the mode in which the engine 5 is stopped. Meanwhile, transition from the hybrid mode to the EV, mode is performed when an SOC is not less than a hybrid upper limit SOC. Transition from the EV mode to the hybrid mode is performed when the SOC is not more than the hybrid upper limit SOC. In this case, in the transition from the hybrid mode to the EV mode and the transition from the EV mode to the hybrid mode, a width of hysteresis characteristics is given in order to prevent a frequent state transition (refer to FIG. 7).

In addition, transition from the first mode section to the second mode section is performed when the vehicle speed is not less than 15 km/h or the SOC is not more than a limit start SOC. Transition from the second mode section to the first mode section is performed when the vehicle speed is not more than 10 km/h and the SOC is not less than the limit start SOC. In this case, in the transition from the first mode section to the second mode section, and the transition from the second mode section to the first mode section, the width of hysteresis characteristics is given in order to prevent the frequent state transition.

The control means 10, as shown in FIG. 3, determines a target engine rpm so as to make a time to reach a maximum engine rpm correspond to a time to reach a maximum vehicle speed when an accelerator is fully opened.

In addition, the control means 10, as shown in FIGS. 4 and 5, makes the target engine rpm lower than the engine rpm at which a maximum power generation efficiency is achieved regardless of the accelerator opening detected by the accelerator opening detecting means 11 when a vehicle speed detected by the vehicle speed detecting means 14 is lower than a preset value.

Furthermore, the control means 10, as shown in FIGS. 5 and 7, makes the engine 5 in a no-load idle operation state when the vehicle speed detected by the vehicle speed detecting means 14 is lower than the preset value and a state-of-charge (SOC) level of the battery 7 is more than a preset state-of-charge (SOC) level.

Furthermore, the control means 10, as shown in FIG. 7, makes as the target engine rpm an engine rpm at which the maximum output is achieved when the state-of-charge (SOC) level of the battery 7 is less than the preset state-of-charge (SOC) level.

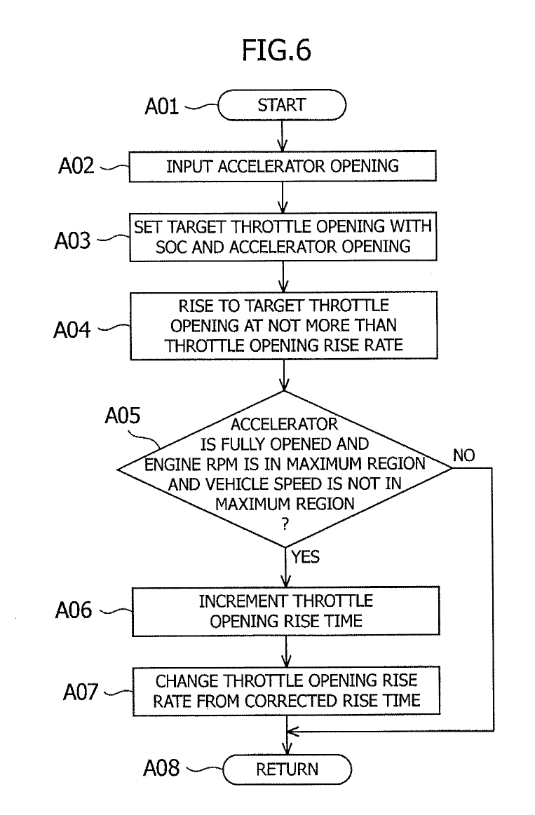

Next, control according to the embodiment will be described based on a flow chart of FIG. 6.

As shown in FIG. 6, when a program starts in the control means 10 (step A01), an accelerator opening is input (step A02), a target throttle opening is set with an SOC and the accelerator opening (step A03), and a throttle opening is raised to the target throttle opening at not more than a throttle opening rise rate (step A04).

Subsequently, it is determined whether or not an accelerator is fully opened, the engine rpm is in a maximum (Max) region, and a vehicle speed is not in a maximum (Max) region (step A05). Here, the maximum (Max) region of the engine rpm is, for example, the region not less than a largest engine rpm, i.e., 1000 rpm. The maximum (Max) region of the vehicle speed is, for example, the region less than a highest vehicle speed, i.e., 10 km/h.

If it is determined to be YES in the step A05, a throttle opening rise time is incremented (increased) (step A06), and, the throttle opening rise rate is changed with the corrected throttle opening rise time (step A07).

After the step A07 is processed, or if it is determined to be NO in the step A05, the program returns (step A08).

Subsequently, control to an SOC when the accelerator opening is zero (0) will be described based on a time chart of FIG. 7.

As shown in FIG. 7, in a state in which the SOC is zero (0) % and the engine 5 has started (time t0), the mode is the hybrid mode in which the slow mode and the silent mode are prohibited, a driving output is zero (0) %, and the engine rpm reaches the output maximum point.

Subsequently, when the SOC reaches 20% (time t1), the driving output begins to rise, after that, when the driving output reaches 100% (time t2), the engine rpm begins to decrease from the output maximum point, and after that, when the SOC reaches 30% to be the limit start SOC and the engine rpm reaches the efficiency maximum point (time t3), prohibiting of the slow mode and the silent mode is released.

After that, a predetermined time M to reach the hybrid upper limit SOC at 50% (time t4) is in the hybrid mode including the slow mode and the silent mode, which is in a region where the hybrid mode is usually used. The engine is stopped at the time t4.

Subsequently, the mode transitions to the EV mode including the slow mode and the silent mode after the time t4.

It is to be noted that in FIG. 7, in stopping the engine start, the SOC is 50% (time t4) and a width of hysteresis characteristics H1 is set at a side with little SOC. In addition, in the release of the prohibiting of the slow mode and the silent mode, the SOC is 30% (time t3) and a width of hysteresis characteristics H2 is set at a side with much SOC.

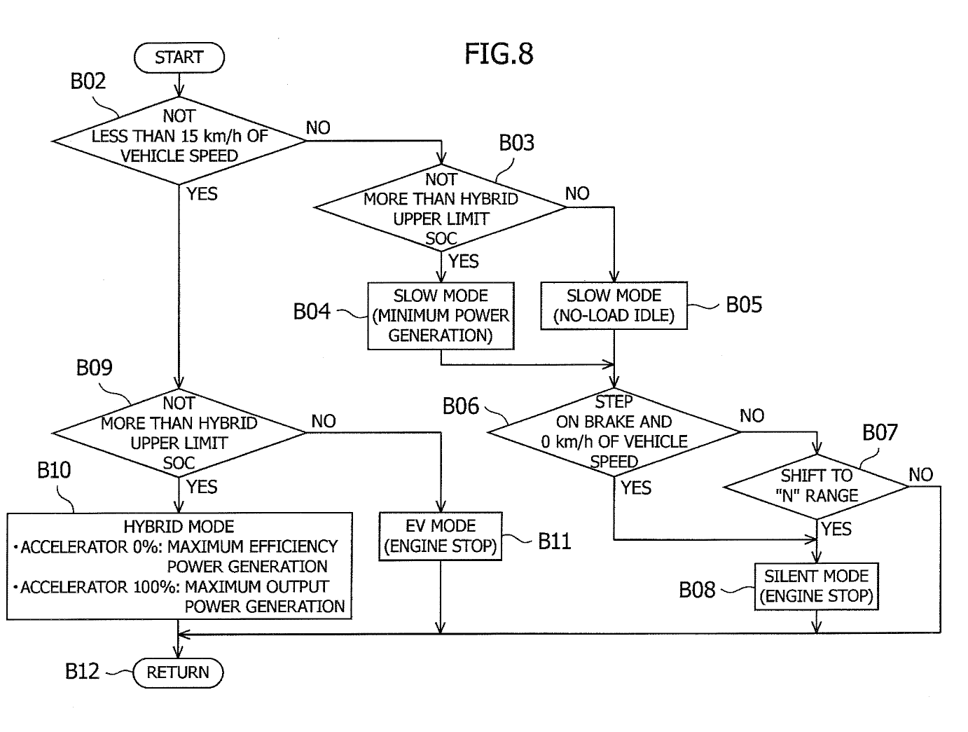

Subsequently, mode transition will be described based on a flow chart of FIG. 8.

As shown in FIG. 8, when program of the control means 10 starts (step B01), first, it is determined whether or not a vehicle speed is not less than 15 km/h (step B02). In this case, a predetermined width of hysteresis characteristics is set to the vehicle speed.

If it is determined to be NO in the step B02, it is determined whether or not the SOC is not more than the hybrid upper limit SOC (step B03).

If it is determined to be YES in the step 803, the mode is set to be the slow mode with the minimum power generation (step 804). It is to be noted that in this case, it is also possible to set to be the hybrid mode, not the slow mode.

If it is determined to be NO in the step B03, the mode is set to be the slow mode with no-load idle operation (step B05).

After the step B04 is processed or after the step B05 is processed, it is determined whether or not a brake is stepped on and the vehicle speed is zero (0) km/h (step B06).

If it is determined to be NO in the step 806, it is determined whether or not a shift position is in an “N” range (step B07).

If it is determined to be YES in the step 807 or YES in the step B06, the mode is set to be the silent mode with the stopped engine (step B08). The slow mode is switched to the silent mode by shifting the shift position into the “N” range. Hence, a driver can switch the mode from the slow mode to the silent mode without adding a new switch etc.

Meanwhile, if it is determined to be YES in the step B02, it is determined whether or not the SOC is not more than the hybrid upper limit SOC (for example, 50%) (step B09).

If it is determined to be YES in the step B09, the mode is set to be the hybrid mode (step B10). In this hybrid mode, the efficiency maximum power generation is achieved when the accelerator opening is zero (0) %, and the output maximum power generation is achieved when the accelerator opening is 100%.

If it is determined to be NO in the step B09, the mode is set to be the EV mode with the stopped engine 5 (step B11).

After the step B0 is processed, after the step B1 is processed, after the step B08 is processed, or if it is determined to be NO in the step B07, the program returns (step B12).

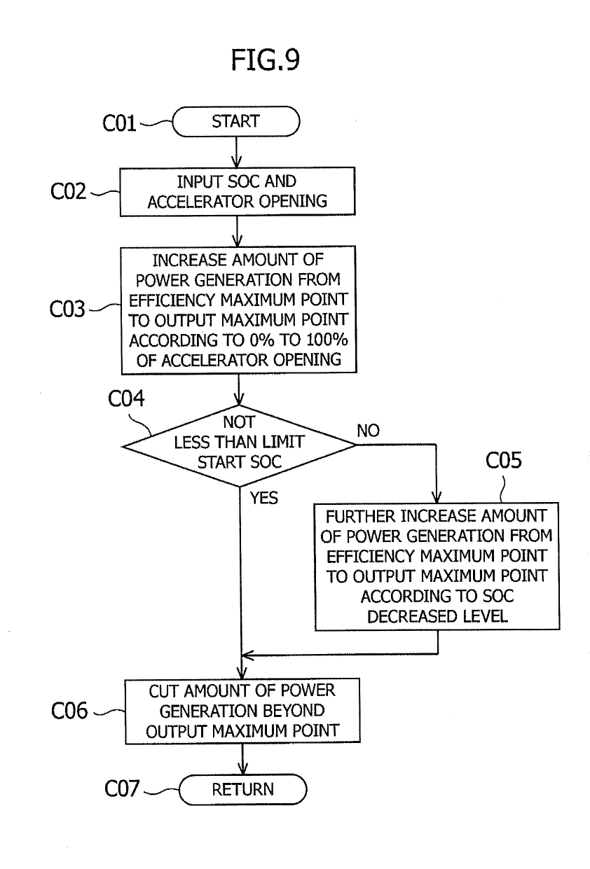

The above-described hybrid mode will be described based on a flow chart of FIG. 9.

As shown in FIG. 9, when a program of the control means 10 starts (step C01), an SOC and an accelerator opening are input (step C02), and an amount of power generation is increased from the efficiency maximum point to the output maximum point according to the 0% to 100% of accelerator opening (step C03), and it is determined whether the SOC is not less than the limit start SOC (step C04).

If it is determined to be NO in the step C04, the amount of power generation is further increased from the efficiency maximum point to the output maximum point according to a decreased level of the SOC (step C05).

If it is determined to be YES in the step C04 or after the step C05 is processed, an amount of power generation beyond the output maximum point is cut (step C06), and the program returns (step C07).

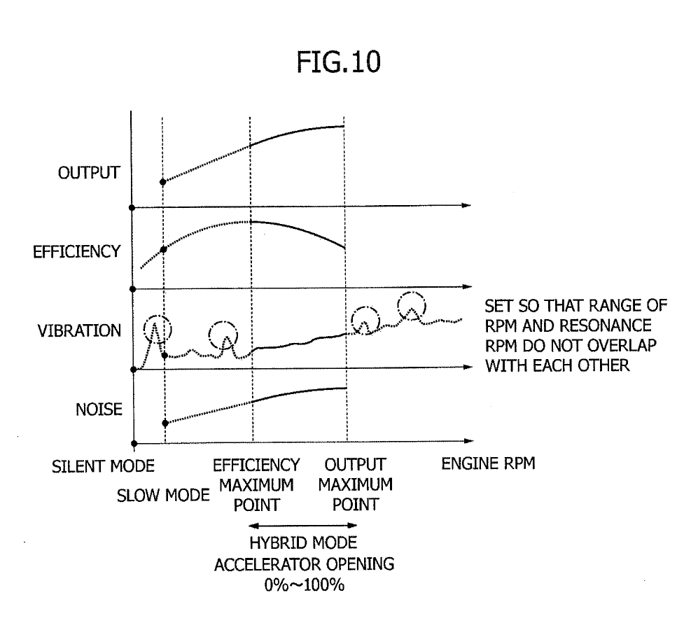

Additionally, in this case, as shown in FIG. 10, in the outputs, the efficiencies, the vibrations, and the noises with respect to the engine rpm, a range of the engine rpm and a resonance rpm are set so as not to overlap with each other, and the hybrid mode according to the accelerator opening (0 to 100%) is used between the efficiency maximum point and the output maximum point.

That is, in a gas vehicle, a throttle opening is large when an accelerator opening is large, an engine rpm rises fast, and much fuel is consumed, while the throttle opening is small when the accelerator opening is small, the engine rpm rises slow, and little fuel is consumed.

Meanwhile, in a series hybrid vehicle, it is possible to operate acceleration and an engine rpm independently, and even if the vehicle is under constant acceleration, a rate of change and a rise-fall direction of the engine rpm can be set freely to some extent.

When an engine load (generator torque) is constant, a rising speed of the engine rpm is increased according to a throttle opening required for the control means 10, and similarly to this, even when the engine rpm is changed on a high efficiency curve in which the engine rpm is equal to the engine load (generator torque), the rising speed of the engine rpm can be changed according to the throttle opening required for the control means 10.

That is, since change of the engine rpm is aimed at improving the acceleration feeling for the driver in the invention according to the embodiment, there is no need for the rising speed of the engine rpm not less than the rising speed of the vehicle speed in fully opened acceleration of the vehicle, and it becomes effective to set the rising speed of the engine rpm to be slow in order not to increase fuel consumption.

The embodiment of the present invention has been described above, and then configurations of the above-mentioned embodiment will be described with respect to aspects of the invention.

First, in an invention according to a first aspect, the control means 10 sets as a target engine rpm an engine rpm at which a power generation efficiency is maximum when the accelerator opening detected by the accelerator opening detecting means 11 is minimum, and sets as the target engine rpm an engine rpm at which an output is maximum when the accelerator opening detected by the accelerator opening detecting means 11 is maximum.

As a result of this, since the engine rpm is increased according to the accelerator opening while maintaining a high fuel efficiency, a driver can be given an acceleration feeling because of the increased engine sound.

In an invention according to a second aspect, the control means 10 is connected to the vehicle speed detecting means 14 that detects a vehicle speed, and sets a target engine rpm to be lower than an engine rpm at which the power generation efficiency is maximum regardless of the accelerator opening detected by the accelerator opening detecting means 11 when the vehicle speed detected by the vehicle speed detecting means 14 is lower than a preset value.

As a result of this, since the engine 5 is driven even when the vehicle 1 moves slowly while reducing fuel consumption, pedestrians can be informed about approach of the vehicle 1.

In an invention according to a third aspect, the control means 10 makes the engine 5 in a no-load idle operation state when the vehicle speed detected by the vehicle speed detecting means 14 is lower than the preset value and a state-of-charge level of the battery 7 is more than a preset state-of-charge level.

As a result of this, since the engine 5 is driven even when the vehicle 1 moves slowly, pedestrians can be informed about approach of the vehicle. Furthermore, since there is no need for power generation when the battery 7 has much state of charge, fuel consumption can be reduced by setting the engine in the no-load idle operation state.

In an invention according to a fourth aspect, the control means 10 sets as the target engine rpm the engine rpm at which the maximum output is achieved when the state-of-charge level of the battery 7 is less than the preset state-of-charge level.

This enables the state of charge not to be decreased when the battery 7 has little state of charge.

In an invention according to a fifth aspect, the control means 10 determines the target engine rpm so as to make a time to reach a maximum engine rpm correspond to a time to reach a maximum vehicle speed when an accelerator is fully opened.

As a result of this, since the rising speed of the engine rpm does not become unnecessarily high, fuel consumption can be reduced. In addition, since the engine rpm is raised according to the rise of the vehicle speed, giving the driver a feeling of strangeness can be avoided.

A control apparatus according to the present invention can be applied to various series hybrid vehicles whether they are of the plug-in type or not.

### DESCRIPTION OF SYMBOLS

1 vehicle

5 engine

6 generator

7 battery

8 drive motor

9 control apparatus

10 control means

11 accelerator opening detecting means

12 brake opening detecting means

13 shift position detecting means

14 vehicle speed detecting means

15 engine RPM detecting means

1. A control apparatus for a series hybrid vehicle including an engine, a generator driven by the engine, a battery charged by the generator, and a motor that drives wheels by generated power of the generator or discharged power of the battery, the control apparatus comprising:
accelerator opening detecting means that detects an accelerator opening; and
control means that determines a target engine rpm based on the accelerator opening detected by the accelerator opening detecting means,
wherein the control means sets as the target engine rpm an engine rpm at which a power generation efficiency is maximum when the accelerator opening detected by the accelerator opening detecting means is minimum and sets as the target engine rpm an engine rpm at which an output is maximum when the accelerator opening detected by the accelerator opening detecting means is maximum.

2. The control apparatus for the series hybrid vehicle according to claim 1, wherein the control means sets as a target engine rpm an engine rpm at which a maximum output is achieved when a state-of-charge level of the battery is less than a preset state-of-charge level.

3. The control apparatus for the series hybrid vehicle according to claim 1, wherein the control means is connected to vehicle speed detecting means that detects a vehicle speed, and sets a target engine rpm to be lower than an engine rpm at which a power generation efficiency is maximum regardless of an accelerator opening detected by the accelerator opening detecting means when the vehicle speed detected by the vehicle speed detecting means is lower than a preset value.

4. The control apparatus for the series hybrid vehicle according to claim 3, wherein the control means sets as a target engine rpm an engine rpm at which a maximum output is achieved when a state-of-charge level of the battery is less than a preset state-of-charge level.

5. The control apparatus for the series hybrid vehicle according to claim 3, wherein the control means makes the engine in a no-load idle operation state when a vehicle speed detected by the vehicle speed detecting means is lower than a preset value and a state-of-charge level of the battery is more than a preset state-of-charge level.

6. The control apparatus for the series hybrid vehicle according to any one of claim 5, wherein the control means sets as a target engine rpm an engine rpm at which a maximum output is achieved when a state-of-charge level of the battery is less than a preset state-of-charge level.

7. A control apparatus for a series hybrid vehicle including an engine, a generator driven by the engine, a battery charged by the generator, and a motor that drives wheels by generated power of the generator or discharged power of the battery, the control apparatus comprising accelerator opening detecting means that detects an accelerator opening; and control means that determines a target engine rpm based on the accelerator opening detected by the accelerator opening detecting means, wherein the control means determines the target engine rpm so as to make a time to reach a maximum engine rpm correspond to a time to reach a maximum vehicle speed when an accelerator is fully opened.
